(19) United States
(12) Patent Application Publication
(10) Pub. No.: US 2010/0003415 A1
(43) Pub. Date: Jan. 7, 2010

(54) High voltage ceramic and glass insulator with function film of resisting pollution flashover and its preparation method

(76) Inventors: Xianzhi Fu, Fujian (CN); Wenlin Zong, Fujian (CN); Ping Liu, Fujian (CN); Qian Shi, Fujian (CN); Wenxin Dai, Fujian (CN); Fuwang Liao, Fujian (CN); Xun Chen, Fujian (CN); Han Lin, Fujian (CN); Xuxu Wang, Fujian (CN); Wenxuan Wu, Fujian (CN); Yu Shao, Fujian (CN); Xueyong Li, Fujian (CN); Lixin Sun, Fujian (CN); Hongxian Chai, Fujian (CN)

Correspondence Address: SAM CHEN, 7F-1, 293, ROOSEVELT ROAD, SEC 3, TAIPEI, TW

(21) Appl. No.: 11/909,862

(22) PCT Filed: Mar. 30, 2006
(86) PCT No.: PCT/CN2006/000563

§ 371 Date: Jun. 22, 2009

(30) Foreign Application Priority Data
Apr. 7, 2005 (CN) 200510018529.7

(51) Int. Cl. B05D 3/02

(52) U.S. Cl. 427/372.2

(57) ABSTRACT

A high voltage ceramic and glass insulator with a function film is provided to resist pollution flashover and a preparation method is provided to produce the high voltage insulators. It is a common high voltage insulator covered with a layer of nano meter level inorganic film with the function of raising pollution flashover resisting, and the film is formed on the high voltage ceramic and glass insulator surface and made of a solution containing the titanium dioxide base, and the solution containing the titanium dioxide base includes a pure titanium dioxide solution or a binary compound oxide solution containing the titanium dioxide. The invention is suitably used for the power transmission and the transform line in the areas with the circumstance seriously polluted or in the remote mountainous areas.

### BACKGROUND OF THE INVENTION

1. Field of the Invention

The invention relates to a preparation method, and more particularly to a preparation method of high voltage ceramic and glass insulator with a function film of resisting pollution flashover.

2. Description of Related Art

A pollution flashover phenomenon of a high voltage ceramic insulator is a serious problem of a high voltage power transmission and the transform line. The pollution flashover phenomenon has a raised trend due to an environment pollution caused by a speedy promoted economy. An effective method for preventing the insulator from a pollution flashover is to clean the surface of the ceramic insulator, periodically. However, the high altitude and electrified operation has a high cost, a low efficiency and the operations quality can not be ensured. In addition, it is easy to cause an industrial injury. Consequently, how to keep the surface of the ceramic insulator in a clean condition for a long time is the key to settle the problem of pollution flashover of a ceramic insulator.

Presently, the research and product development of the high voltage ceramic insulator with the function of resisting pollution flashover are focus on three aspects.

A. Promoting the surface of the ceramic insulator is to provide an organic coating on the surface of the ceramic insulator. The coating material is macromolecule material and has the characteristics of water-proof and good insulation, such as RTV paint.

B. Directly using the macromolecule material to make an insulator. Most of the macromolecule material uses the silica gel as a base and add together coupling agents, combustion-supporting agents, antioxidants and loose-fill material. Presently, the insulator made of polytetrafluoroethylene has a high quality and a best shape.

C. An inorganic semi-conductor glaze coating is sintered on the surface of the insulator to promote the ability of resisting pollution flashover of the insulator. The glaze coating is integrally sintered with the ceramic over 1,100° C. and a glassy mixed plane that contains a little conductive big crystal. The surface electric resistance rate of the semi-conductor containing glassy (20%-30%) is lower than that of the typical glaze. Consequently, the electric leakage current, during operating, heats the insulator to evaporate the moisture on the surface of the insulator and prevent the pollution flashover electric current passing there through for achieving the objective of resisting pollution flashover.

The ability of resisting pollution flashover of the above three types of insulators are promoted relative to the conventional insulators that are made of ceramic and widely used. However, the above three types of insulators contains the disadvantages including a high price, a weak strength and a feeble ability of anti-oxidation. Especially, the conventional insulators can not reduce the filth pile up the surface thereof. As a result, that can not eliminate the insulators from pollution flashover.

The invention has arisen to mitigate and/or obviate the disadvantages of the conventional ceramic insulators.

### SUMMARY OF THE INVENTION

A primary objective of the invention is to provide an improved high voltage ceramic and glass insulator with a function film of resisting pollution flashover.

To achieve the objective, it is provided a common high voltage insulator covered with a layer of nano meter level inorganic film with the function of raising pollution flashover resisting, and the film with pollution flashover resisting function is formed on the high voltage ceramic and glass insulator surface and made of a solution containing the titanium dioxide base, and the solution containing the titanium dioxide base includes a pure titanium dioxide solution or a binary compound oxide solution containing the titanium dioxide. The invention is suitably used for the power transmission and the transform line in the areas with the circumstance seriously pollution or in the remote mountainous areas, and it can coats the insulators on line directly with the solution to improve the pollution flashover resisting function of the conventional insulator having existed on the current line.

The advantages and the benefits of the invention are follows. The high voltage ceramic and glass insulator with a function film of resisting pollution flashover in accordance with the invention is anti-oxidation, anti-static and anti-pollution, and has a equally distributed voltage. Compared with a semi-conductor ceramic insulator, the electric conduction layer is altered from a millimeter level to a nano level and the impedance property changed. As a result, the current of an electric leakage is remarkably reduced during operation for saving energy. In addition, the film of the nano crystal structure changes the dielectric constant of the surface of the insulator and reduces the static electricity accumulated on the surface of the insulator and the dust adhered on the surface of the insulator to prevent the insulator from a pollution flashover under the condition of containing the insulating property of the insulator, and the voltage is equally distributed on the surfaces of a series of insulators for preventing the insulators from a flashover due to a partial high voltage. Compared with the macromolecule material paint and macromolecule material synthesized insulator, the inorganic film on the surface of the insulator in accordance with the invention has the advantages including high chemical stability and a long use life. In addition, the nano film on the surface of the insulator can reduce the pollution on the surface of the insulator and the flashover caused by pollution.

Further benefits and advantages of the invention will become apparent after a careful reading of the detailed description with appropriate reference to the accompanying drawings.

### DETAILED DESCRIPTION OF THE INVENTION

The preparation method of high voltage ceramic and glass insulator with function film of resisting pollution flashover in accordance with the invention comprises the processes as follows.

### A. The Preparation Methods of Titanium Dioxide Based Solution:

(a) The pure titanium dioxide solution is first prepared. The alcoholate of titanium is hydrolyzed under the conditions of acidity pH<5 or alkaline pH>7 and getting a transparent and well mixed solution. Finally, the pH value of the titanium solution is dialyzed—into 1˜5. In this solution, the weight percentage of the titanium dioxide, in this solution, is 0.01˜10.0 and the other is water.

(b) The compound titanium dioxide solution is prepared by a conventional process of preparing compound titanium dioxide solution of the preparation method of the binary compound oxide base that contains titanium dioxide. The pH value of the compound titanium dioxide solution is dialyzed into 1˜5. The weight percentage of the titanium dioxide, in this solution, is 0.01˜10.0 and another oxide is 0.01˜5.0.

(c) A surface active agents is added to the titanium dioxide solution or the binary compound oxide solution containing titanium dioxide and the surface active agents has a weight percentage 0.01˜20.0. The surface active agents is selected from one or more kinds of the polyvinyl alcohol, the polyethylene glycols (PEG), the perfluoro alkyl carboxylic acid and the carboxylate thereof, the perfluoro alkyl sulfonates, and the nonionic surfactants that contains fluorine. The nonionic surfactants include the perfluoro octyl sulfonic acid diethanolamines, the N-propyl-N perfluoro octyl ammonium sulfonate and the diblock copolymer poly perfluoro alkane.

B. Preparation Method of a High Voltage Ceramic Insulator with Nano Inorganic Film of Resisting Pollution Flashover:

The titanium dioxide based solution, from the above method, is brushed or sprayed on the surface of the high voltage ceramic insulator to form a nano inorganic film of resisting pollution flashover. The spread techniques are divided into two types, including on-line and off-line. The on-line type is processed on the surface of the semi-finished ceramic insulator after being encaustic and the off-line type is processes on the surface of the finished ceramic insulator that has a metal cap and a metal plug glued thereon. After being spread, a nano inorganic film of resisting pollution flashover is formed on the surface of the ceramic insulator through a low temperature heat treatment.

(a) In the on-line type for forming an inorganic film of resisting pollution flashover on the surface of the high voltage ceramic insulator, the spread techniques are divided into two types. In the first type, the high voltage ceramic insulator is cooled down to the temperature under 400° C. and spread titanium dioxide based solution in a high temperature. Continually, one of the following techniques is selected to finish the process of forming film. (1) The temperature is automatically cooled under 100° C. on the produce line. (2) The temperature is cooled under 100° C. on the produce line after being kept warm for two hours and the cooling rate is controlled under 30° C./min. (3) After being spread, the temperature in the produce line is raised to 300˜700° C., kept warm for 5˜300 minutes or does not keep warm, and cooled under 100° C. The heating and cooling rate are controlled under 30° C./min. As to the ceramic insulator having a complicated shape, an extra-thin or an extra-thick thickness, the heating and cooling rate are controlled under 10° C./min. In the second type that is processed after the glazed being finished, the insulator is cooled to normal temperature and spread with the titanium dioxide based solution. After being spread, the insulator is sequentially heated, kept warm and cooled. The heating rate corresponds to the bear ability of the ceramic product. The temperature of the heated insulator is kept in 300˜700° C. within 200 minutes and cooled under 100° C. The cooling rate of this type is the same as that of the first type. The ceramic insulator of resisting pollution flashover, from the above two types, can be assembled with a metal cap and a metal plug according to the downstream preparation procedures thereof.

In the off-line type for forming an inorganic film of resisting pollution flashover on the surface of the high voltage ceramic insulator, the high voltage ceramic insulator is spread with titanium dioxide based solution in a normal temperature. The temperature of the spread ceramic insulator is raised to 200˜350° C. under the rate of 1˜10° C. and kept for 30˜200 minutes. Finally, the temperature of the ceramic insulator is cooled under 100° C. under the rate of 1˜3° C./min. The heat treatment procedures are processed in an oven or a kiln.

C. Preparation Method of a High Voltage Glass Insulator with Nano Inorganic Film of Resisting Pollution Flashover:

The surface of the finished glass insulator is spread with titanium dioxide based solution under the normal temperature. The temperature of the spread glass insulator is raised to 200˜350° C. under the rate of 1˜10° C. and kept for 30˜200 minutes. Finally, the temperature of the glass insulator is cooled under 100° C. under the rate of 1˜10° C./min. The heat treatment procedures are processed in an oven or a kiln.

### D. Controlling the Spread Quantity

In the above spread process of titanium dioxide based solution, the spread quantity is 2˜20 ml/m2. In the preferred embodiment of the invention, the spread quantity is 3˜5 ml/m2.

### First Embodiment—The Preparation Method of the Titanium Dioxide Based Solution

The thick nitric acid (68%) 1.1 ml is provided into deionized water 150 ml for blend into a well mixed solution. Tetraisopropyl titanate 12.5 ml is slowly dripped into the solution under strongly stir and hydrolyzed to form a suspension containing white precipitation. The suspension is continually stirred for dissolving the precipitation and forming a well mixed transparent solution. The transparent solution is arranged into a dialysis film bag with two liters deionized water for processing dialysis procedure. The deionized water is replaced every twelve hours till the pH value is 3.2. The titanium dioxide solution is taken out of the dialysis film bag, wherein the weight percentage is 2.5.

### Second Embodiment—The Preparation Method of Titanium Dioxide-Silicon Dioxide Compound Solution

The ethyl orthosilicate is slowly dripped into a solution that contains thick nitric acid (68%) 0.25 ml and deionized water 10 ml and stirred into a well mixed transparent silicon dioxide solution. The silicon dioxide solution (10 ml) and the titanium dioxide solution (100 ml, for the first embodiment) are well mixed and processed dialysis procedure, as described in first embodiment) till the pH value is 2.3. Finally, polyethylene glycols for 5.0 gm is added into the titanium dioxide-silicon dioxide compound solution under electromagnetic Stirring and well mixed. This solution contains titanium dioxide for weight percentage 2.3 and silicon dioxide for weight percentage 1.1 and the pH value is 2.8.

### Third Embodiment—Preparation of the High Voltage Ceramic Insulator of Resisting Pollution Flashover

The titanium dioxide solution 2.0 ml, form the first embodiment, is spread on the surface of the ceramic insulator by a spread gun having a gauge of 1.2 mm. The spread insulator is moved into a furnace and heated to 300° C. according to the rate of 2° C./min. The heated insulator is kept warm for two hours and taken out of the furnace after being cooled to the normal temperature.

### Fourth Embodiment—Electrical Breakdown Voltage Testing in Transformer Oil for the High Voltage Ceramic Insulator of Resisting Pollution Flashover

The high voltage ceramic insulator form the third embodiment is provided for an electrical breakdown voltage testing in transformer oil and the provided voltage is alternating current. Some typical insulators are provided for a comparative test under the same conditions. The result is shown in the table 1 as follows.

TABLE 1
Breakdown Voltage of Insulator in the Transformer Oil

| | Insulator of the invention | | Typical Insulator | |
|---|---|---|---|---|
| Specimen | 1^{#} | 2^{#} | 3^{#} | 4^{#} |
| Breakdown voltage (kV) | 145 | 140 | 150 | 150 |

The result as shown in table 1, the high voltage ceramic insulator of resisting pollution flashover has an ability of surface of the typical anti-voltage close to that of the typical insulator, and be conformed to the National Standard of PRC (People's Republic of China).

### Fifth Embodiment—Anti-Pollution Ability Test for the High Voltage Ceramic Insulator of Resisting Pollution Flashover

The ceramic insulator, form the third embodiment, is placed outdoors, under normal conditions, for observing the ability of anti-pollution of the surface thereof relative to a typical ceramic insulator. The surface of the ceramic insulator of resisting pollution flashover is almost originally clean after placed outdoors for fifteen days and the surface of the typical ceramic insulator has particles of dust adhered thereto. In addition, the color of the surface of the typical ceramic insulator becomes gloomy.

(b) The ceramic insulators are placed outdoors after being severely processed. The high voltage ceramic insulator (1#) of resisting pollution flashover, from the fourth embodiment after being tested, has some transformer oil adhered thereto and is placed outdoors with the typical ceramic insulator (3#). Being outdoors placed for one week, the surface of the specimen (1#) is clean, the greasiness on the periphery of the specimen (1#) is decomposed and the mist is equally distributed of the surface of the specimen (1#). However, the surface of the specimen (3#) has some dust adhered thereon, the greasiness on the periphery of the specimen (3#) is not decomposed and the mist is congealed thereon. As a result, the ceramic insulator of resisting pollution flashover shows a good ability of anti-pollution.

### Sixth Embodiment—Evaluation of the Decontamination of the High Voltage Ceramic Insulator of Resisting Pollution Flashover

(a) Illumination watercolor fading without electric field action: The surface of the ceramic insulator from the third embodiment is applied with watercolor. The watercolor is faded after five minutes for being illuminated with a 365 nm ultraviolet lamp. However, the watercolor of the surface of the typical ceramic insulator has no change under the same conditions of the ceramic insulator from the third embodiment.

(b) Illumination watercolor fading with an electric field action: The ceramic insulator from the third embodiment is connect a typical ceramic insulator and placed in an electric field of 50 KV. The ceramic insulator from the third embodiment and the typical ceramic insulator are coated with watercolor and exposed under sunlight for five minutes. The watercolor of the ceramic insulator from the third embodiment is faded and the watercolor of the surface of the typical ceramic insulator has no change under the same conditions.

### Seventh Embodiment—The Evaluation of the Machinery and Electric Properties of the High Voltage Ceramic Insulator of Resisting Pollution Flashover

The machinery and electric properties of the high voltage ceramic insulator from the third embodiment are test under GB/T 775.2-2003 (National Standard of PRC). The test items include the electromechanical breaking load and the electrical breakdown voltage. The test results are shown in the table 2 as follows.

TABLE 2
Result of electromechanical breaking
load and electrical breakdown voltage

| | Electromechanical | | | | Electrical breakdown | | |
|---|---|---|---|---|---|---|---|
| | breaking load value (kN) | | | | voltage (kV) | | |
| Insulator of the | 106 | 101 | 105 | 106 | >120 | >120 | >120 |
| invention | | | | | | | |
| Typical insulator | 107 | 106 | 108 | 103 | >120 | >120 | >120 |

As shown in table 2, the machinery and electric properties of the high voltage ceramic insulator of the invention are similar to that of the typical ceramic insulator and conformed to the National Standard of PRC.

### Eighth Embodiment—The Capacitance Test of the High Voltage Ceramic Insulator of Resisting Pollution Flashover

A capacitance test is processed to seven series connected ceramic insulators from the third embodiment. The capacitance value of the seven series connected ceramic insulators is 5.158 pF during providing a high voltage of 10 kV. The capacitance value of the seven series connected conventional ceramic insulators is 4.917 pF. As a result, the capacitance value of the ceramic insulator of the invention is promoted.

### Ninth Embodiment—The Leakage Current of the High Voltage Ceramic Insulator of Resisting Pollution Flashover of the Invention

A leakage current test is processed to seven series connected ceramic insulators from the third embodiment. The leakage current (full current) of the seven series connected ceramic insulators is 146.5 μA during providing a high voltage of 63.54 kV. The capacitance value of the seven series connected conventional ceramic insulators is 136.1 μA. As a result, the capacitance value of the ceramic insulator of the invention is slightly promoted and shows some characteristics of a semi-conductor.

### Tenth Embodiment—The Coat on the Surface of the Insulator of the Titanium Dioxide Solution Containing Surface Active Agents and the Electric Characteristics Thereof

(a) Spreading: According to the method of third embodiment, 6.0 ml solution from second embodiment is spread on the surface of the insulator (XWP-160) for getting a nano inorganic titanium dioxide base film.

(b) Electric characteristics: According to the method of fourth embodiment, the seventh embodiment, the eighth embodiment and the ninth embodiment, the breakdown voltage of the above insulator in the transformer oil is 128 kV, the electromechanical breaking load value is 105 kN, the electrical breakdown voltage is greater than 120 kV, the capacitance is 5.531 pF and the leakage current is 175.3 μA. As a result, the film from the method of the invention conform to the routines electric properties of an insulator.

### Eleventh Embodiment—The Preparation Method of the Titanium Dioxide Based Solution Containing Hydrogen Peroxide

The industry hydrogen peroxide for 0.1 ml is added into the titanium dioxide solution from the first embodiment for 100 ml and well stirred.

### Twelfth Embodiment—The Preparation Method of the Titanium Dioxide Film on the Surface of the Resisting Pollution Flashover Insulator that is Processed Under Normal Temperature

The titanium dioxide solution 3.0 ml, form the eleventh embodiment, is spread on the surface of a normal insulator by a spread gun having a gauge of 1.2 mm. The spread insulator is naturally dried.

### Thirteenth Embodiment—The Resisting Pollution Evaluation of the High Voltage Resisting Pollution Flashover Ceramic Insulator that is Processed Under Normal Temperature

The ceramic insulator, from the twelfth embodiment, is placed outdoors for observing the resisting pollution property and compared with a typical insulator. After 15 days, the surface of the insulator with a film almost has no change formed thereon. There is dust adhered on the surface of the typical insulator and the color of the surface of the typical insulator is faded.

Although the invention has been explained in relation to its preferred embodiment, it is to be understood that many other possible modifications and variations can be made without departing from the spirit and scope of the invention as hereinafter claimed.

What is claimed is:

1. A preparation method of a high voltage ceramic and glass insulator with a function film of resisting pollution flashover, comprising the steps of:
(a) preparing a titanium dioxide based solution including the sub-steps of preparing a pure titanium dioxide solution including titanium dioxide and preparing a binary compound oxide solution including titanium dioxide;
(b) spreading the titanium dioxide based solution on a surface of a high voltage ceramic insulator and on a surface of a glass insulator respectively; and
(c) spreading the insulator to form a nano inorganic film of resisting pollution flashover after a heat treatment.

2. The preparation method as claimed in claim 1, wherein a surface active agent is added to the titanium dioxide based solution after step (a).

3. The preparation method as claimed in claim 1, wherein a weight percentage of the titanium dioxide in the pure titanium dioxide solution is from 0.01 to 10.0%.

4. The preparation method as claimed in claim 3, wherein the remaining composition of the pure titanium dioxide solution is water.

5. The preparation method as claimed in claim 1, wherein a weight percentage of the titanium dioxide in the binary compound oxide solution is from 0.01 to 10.0%.

6. The preparation method as claimed in claim 2, wherein the surface active agent is selected from one or more of polyvinyl alcohol, polyethylene glycols (PEG), perfluoro alkyl carboxylic acid and carboxylate thereof, perfluoro alkyl sulfonates, and nonionic surfactants having fluorine.

7. The preparation method as claimed in claim 1, wherein the nano inorganic film of the high voltage ceramic insulator is formed either on a surface of a finished ceramic insulator having a metal cap and a metal plug adhered thereon, or on a surface of a half-finished ceramic insulator that is glazed.

8. The preparation method as claimed in claim 7, wherein finished ceramic insulator is heated to a temperature of between 200° C. and 350° C. at a rate of from 1 to 10° C./min and kept for a time of from 30 to 200 minutes.

9. The preparation method as claimed in claim 8, wherein finished ceramic insulator is further cooled to a temperature below 100° C. at a rate of from I to 3° C./min.

10. The preparation method as claimed in claim 7, wherein the forming of the nano inorganic film on the surface of the half-finished ceramic insulator is done in an on-line sub-step.

11. The preparation method as claimed in claim 7, wherein the forming of the nano inorganic film on the surface of the half-finished ceramic insulator is done in an off-line sub-step.

12. The preparation method as claimed in claim 10, wherein in the on-line sub-step the ceramic insulator is cooled to a temperature below 400° C. and after spreading the titanium dioxide based solution in step (b), either cooling to a temperature below 100° C. or cooling to a temperature below 100° C. after being kept at a temperature above 100° C. for two hours with the cooling rate being controlled under 30° C./min, heating to a temperature of between 300° C. and 700° C., either substantially keeping the temperature for a time of from 5 to 300 minutes or without keeping the temperature, and cooling to a temperature below 100° C. so as to finish the forming of the nano inorganic film on the surface of the half-finished ceramic insulator.

13. The preparation method as claimed in claim 11, wherein in the off-line sub-step after the glazing, the ceramic insulator is cooled to a first predetermined temperature and after spreading the titanium dioxide based solution in step (b), the ceramic insulator is heated to a temperature of at least 700° C., kept in a temperature of between 300° C. and 700° C. for about 200 minutes, and cooled below 100° C., and wherein both the heating and cooling rates are controlled at a rate less than 30° C./min.

14. The preparation method as claimed in claim 1, wherein the surface of the glass insulator is spread with the titanium dioxide based solution by heating to a second predetermined temperature.

15. The preparation method as claimed in claim 14, wherein the second predetermined temperature is between 200° C. and 350° C. at a heating rate of between 1 and 10° C./min, and wherein the second predetermined temperature is kept for a time of between 30 to 200 minutes.

16. The preparation method as claimed in claim 15, wherein the glass insulator is cooled below 100° C. at a cooling rate of between 1 and 10° C./min.

17. The preparation method as claimed in claim 1, wherein a spread quantity of the titanium dioxide based solution is from 2 to 20 ml/m².
